(19) United States
(12) Patent Application Publication
(10) Pub. No.: US 2026/0140363 A1
(43) Pub. Date: May 21, 2026

(54) SPHERICAL FLEXURE GIMBAL

(71) Applicant: BAE Systems Space & Mission Systems Inc., Broomfield, CO (US)

(72) Inventors: Scott Miles Balaban, Broomfield, CO (US); Aaron Michael Long, Erie, CO (US); Radford James Fagan, Boulder, CO (US); Alexander William Pitt, Broomfield, CO (US)

(73) Assignee: BAE Systems Space & Mission Systems Inc., Broomfield, CO (US)

(21) Appl. No.: 19/389,217

(22) Filed: Nov. 14, 2025

Related U.S. Application Data
(60) Provisional application No. 63/723,277, filed on Nov. 21, 2024.

(51) Int. Cl. G02B 26/10; F16M 11/12; F16M 11/18; F16M 11/22

(52) U.S. Cl. CPC G02B 26/105; F16M 11/12; F16M 11/18; F16M 11/22

(57) ABSTRACT

Support assemblies, assemblies incorporating support assemblies, and methods for providing and operating support assemblies are disclosed. A support assembly as disclosed herein includes a base interconnected to a platform by first and second crossed four bar linkages. The first crossed four bar linkage occupies a plane that intersects a plane occupied by the second crossed four bar linkage. Each of the links in each of the crossed four bar linkages includes a clearance feature that establishes an open volume around a central axis or center line of the support assembly. Actuators can cause the platform to tilt relative to the base by pivoting one or both of the selected crossed four bar linkages relative to the base. Position sensors can be included determine an amount that the platform is tilted relative to the base.

### CROSS-REFERENCE TO RELATED APPLICATION

This application claims the benefit of U.S. Provisional Patent Application Ser. No. 63/723,277, filed Nov. 21, 2024, the entire disclosure of which is hereby incorporated herein by reference.

### FIELD

The present disclosure provides support assemblies or systems for supporting and selectively orienting objects, such as but not limited to mirrors, relative to a base.

### BACKGROUND

Suspension systems that provide a flexible support assembly having two degrees of freedom of rotation about a desired point have a number of applications. An optical scanning system in which a mirror is selectively oriented in order to point a beam of light in a desired direction is one example of a system that requires a flexible suspension system having a high scanning frequency. In scanning systems that use a mirror to rapidly scan back and forth across an angular excursion, suspension component friction must be kept to a minimum in order to permit a high scanning frequency. It is also desirable to provide rotational freedom about two orthogonal axes while controlling or minimizing translational movement of the mirror or other supported object.

Many of the suspension systems that have been developed for supporting objects such as steering mirrors while providing two degrees of rotational freedom require a relatively large number of separate components. Such systems can also require a relatively large amount of power to operate, and can suffer from relatively slow rates of slew, limited travel, and calibration drift. Various prior suspension system configurations have also been relatively large, have lacked adequate angular movements, and have lacked adequate movement accuracy.

### SUMMARY

Embodiments of the present disclosure provide suspension or support systems and assemblies that enable a supported object to be rotated or tilted about two perpendicular axes. A support assembly as disclosed herein includes a support structure that interconnects a base assembly to a supported object. The support assembly can include a pair of planar four bar linkages. Each of the four bar linkages includes a pair of crossed links that extend between a base and a platform. Moreover, the four bar linkages can be disposed within planes that intersect one another. A center section of each of the links can be offset from a plane in which the joints of the associated linkage are disposed to form an open volume along a center line of the support assembly. Actuators are provided to enable the platform and a supported object attached to the platform to be rotated or tipped about a selected axis. Position sensors can also be included to provide signals related to an amount of rotation or tilt about a selected axis.

A first end of each of the links of the four bar linkages is interconnected to the base by a base joint, and a second end of each of the links of the four bar linkages is interconnected to the platform by a platform joint. The base and platform joints can include universal joints or gimbals that allow a connected link to pivot about two orthogonal axes. In accordance with at least some embodiments of the present disclosure, the base joints and the platform joints are implemented as flexural pivot structures.

At least one actuator is provided for each of the two orthogonal axes about which the platform can be tilted. In accordance with at least some embodiments of the present disclosure, a first actuator is disposed along a first axis that is coincident with a plane of the first four bar linkage, and a second actuator is disposed along a second axis that is coincident with a plane of the second four bar linkage. In accordance with still further embodiments, two actuators can be disposed along the first axis and a further two actuators can be disposed along the second axis. In such embodiments, operation of an actuator associated with the first four bar linkage allows the platform to be tipped about the first axis, while operation of an actuator associated with the second four bar linkage allows the platform to be tipped about the second axis. Other configurations of actuators are possible. As examples, but without limitation, an actuator can be implemented as a voice coil motor or a stepper motor.

At least one position sensor can be provided for each of the two orthogonal axes about which the platform can be tilted. In accordance with at least some embodiments of the present disclosure, position sensors can be disposed along the same axes as the actuators. As examples, but without limitation, each actuator can be implemented as an encoder, an eddy current sensor, a differential impedance transducer type proximity sensor, or an optical sensor.

Methods of supporting an object in accordance with embodiments of the present disclosure include providing a base that is configured to interconnect to a base assembly, and a platform that is configured to interconnect to a supported object. A first four bar linkage with crossed links interconnects the base and the platform via joints having two orthogonal axes of rotation, where one of the axes is coincident with a plane of the first four bar linkage. A second four bar linkage with crossed links interconnects the base and the platform via joints having two axes of rotation, where one of the axes is coincident with a plane of the second four bar linkage. The plane of the first four bar linkage can be orthogonal to the plane of the second four bar linkage. According to the method, the platform, and thus a supported object interconnected to the platform, can be tipped about a first axis by tipping the first four bar linkage about the axis that is coincident with the plane of the first four bar linkage using a first actuator. This tipping causes the crossed links of the second four bar linkage to pivot about each of the joints of the second four bar linkage, in turn tipping or rotating the platform about the first axis. Similarly, the platform can be tipped or rotated about a second axis by tipping the second four bar linkage about the axis that is coincident with the plane of the second four bar linkage using a second actuator. An amount by which the platform is tipped relative to the base can be measured using one or more position sensors disposed about the first and second axes.

Additional features and advantages of embodiments of the present disclosure will become more readily apparent from the following description, particularly when taken together with the accompanying drawings.

### BRIEF DESCRIPTION OF THE DRAWINGS

FIG. 1A is a top perspective view of a system incorporating a support assembly in accordance with embodiments of the present disclosure;

FIG. 1B is a bottom perspective view of the system of FIG. 1A;

FIG. 2A is a top perspective view of a support assembly in accordance with embodiments of the present disclosure;

FIG. 2B is a first side elevation view of the support assembly of FIG. 2A;

FIG. 2C is a second side elevation view of the support assembly of FIG. 2A;

FIG. 2D is a top plan view of the support assembly of FIG. 2A;

FIG. 3A is top perspective view of the support assembly of FIG. 2A, depicted with a platform element tilted relative to a base element;

FIG. 3B is a side elevation view of the support assembly of FIG. 3A;

FIG. 4A depicts a relationship between components of a support assembly in accordance with embodiments of the present disclosure in a side elevation view;

FIG. 4B depicts a relationship between the components of the support assembly of FIG. 4A, with a platform element tilted relative to a base element;

FIG. 5A is a side elevation view of a link and associated joint elements of a support assembly in accordance with embodiments of the present disclosure;

FIG. 5B is a first perspective view of the link and associated joint elements of FIG. 5A;

FIG. 5C is a second perspective view of the link and associated joint elements of FIG. 5A;

FIG. 6 depicts a flexure such as may be included in a joint in accordance with embodiments of the present disclosure;

FIG. 7 is a functional block diagram depicting components of a system in accordance with embodiments of the present disclosure; and

FIG. 8 is a flowchart depicting aspects of a method for providing and operating a system incorporating a support assembly in accordance with embodiments of the present disclosure.

### DETAILED DESCRIPTION

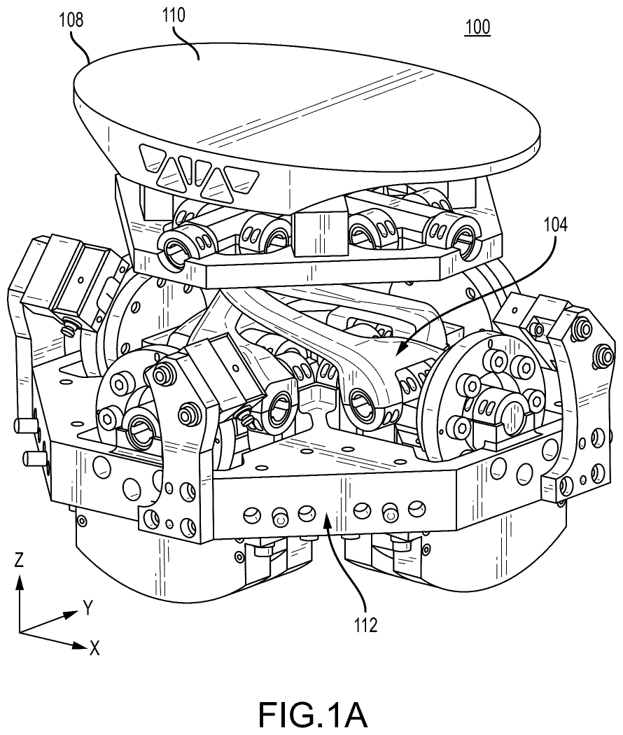

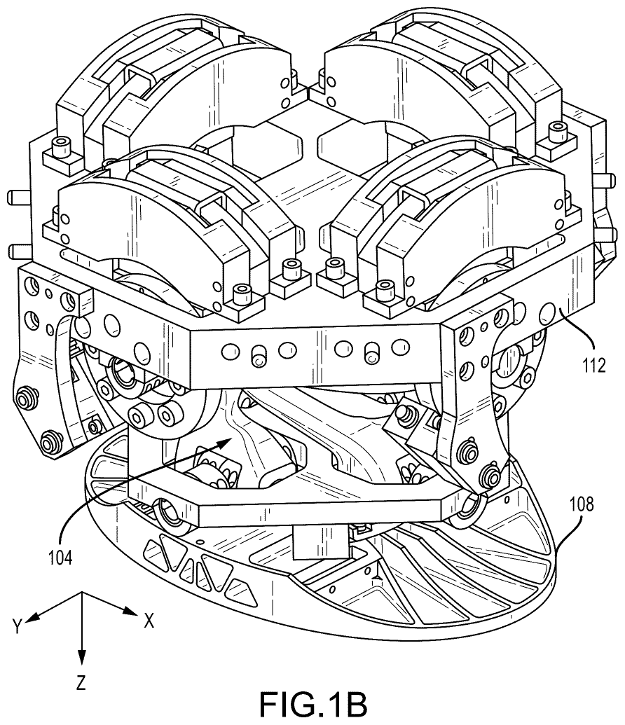

With reference now to FIG. 1A, a system 100 that includes a support assembly 104 in accordance with embodiments of the present disclosure is depicted in a top perspective view. FIG. 1B depicts the system 100 of FIG. 1A in a bottom perspective view. In general, the support assembly 104 joins or interconnects a supported object 108 to a base system or base assembly 112. As discussed in greater detail elsewhere herein, the support assembly 104 can include a support mechanism in the form of a pair of crossed four bar linkages, a plurality of actuators or motors, and a plurality of position sensors or encoders. As also discussed in greater detail elsewhere herein, embodiments of the present disclosure enable a supported object 108 to be moved relative to a base assembly 112 at high levels of precision and speed. In accordance with at least some embodiments of the present disclosure, the support assembly 104 permits a tilting or rotational movement of the supported object 108 relative to the base assembly 112. In particular, the movement of the supported object 108 can be a tilt or rotation about a first axis (X) and/or a second axis (Y), where the first and second axes are orthogonal to one another. In accordance with further embodiments of the present disclosure, the support assembly 104 can permit movement of the supported object 108 relative to the base assembly 112 about one or both of the first axis (X) and the second axis (Y), while eliminating or minimizing translational movement of the supported object 108 relative to the base assembly 112, and while eliminating or minimizing rotation of the supported object 108 about the Z axis, where the Z axis is orthogonal to the X and Y axes. Accordingly, the system 100 enables tip-tilt movements of the supported object 108 to be performed relative to the base assembly 112. In the illustrated example, the system 100 is a steering mirror assembly and the supported object 108 is a mirror 110. However, the supported object 108 is not limited to any particular object or assembly.

In accordance with at least some embodiments of the present disclosure, the support assembly 104 behaves like a spring, and thus returns the supported object 108 to a center or neutral position in the absence of the application of a force. This neutral position can be one at which a plane of the supported object 108 is parallel to a plane of the base assembly 112, or it can be one at which a plane of the supported object 108 is at some non-parallel angle to a plane of the base assembly 112. In addition, the support assembly 104 can allow for relatively large angles of travel about the two rotational axes X and Y, while providing low suspension component friction to permit a high scanning frequency, and a fixed or constrained pivot point or point of rotation to minimize or limit translational movement of the supported object 108. As an example, but without limitation, the angles of travel about each rotational axis can be +/−20°. In addition, a support assembly 104 as disclosed herein can provide an open volume disposed along a center line of the support assembly, providing space for a drive well or other mechanisms behind the supported object 108. A support assembly 104 as described herein can also use fewer parts, can be more compact, can require less power, can enable larger travel, can enable faster slew, can provide improved pointing capability, and can experience less calibration drift as compared to alternative support systems.

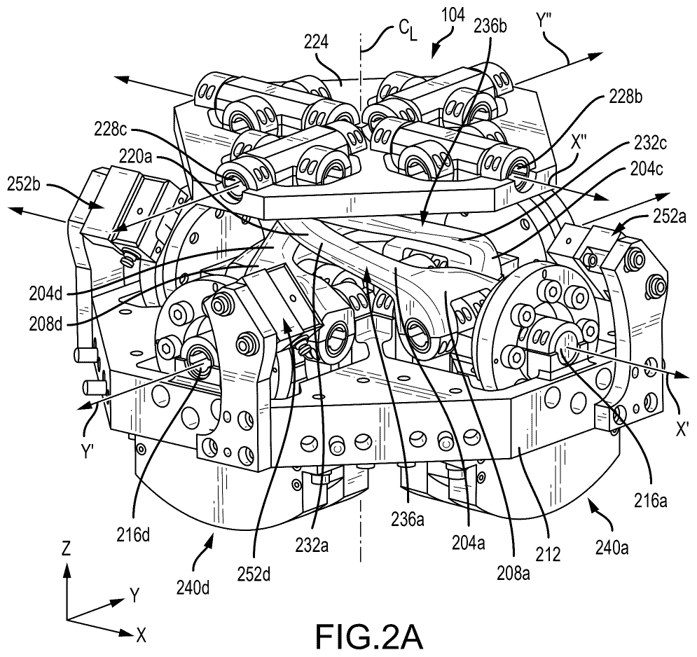

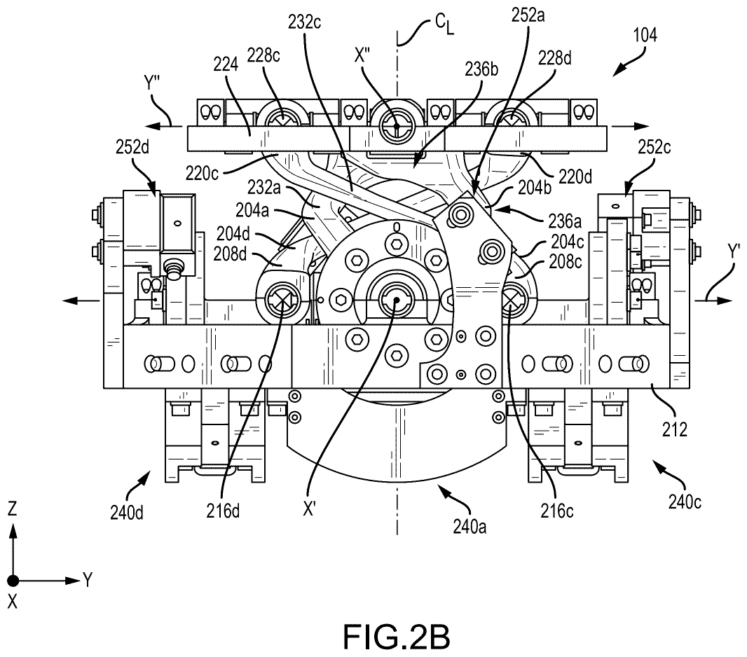

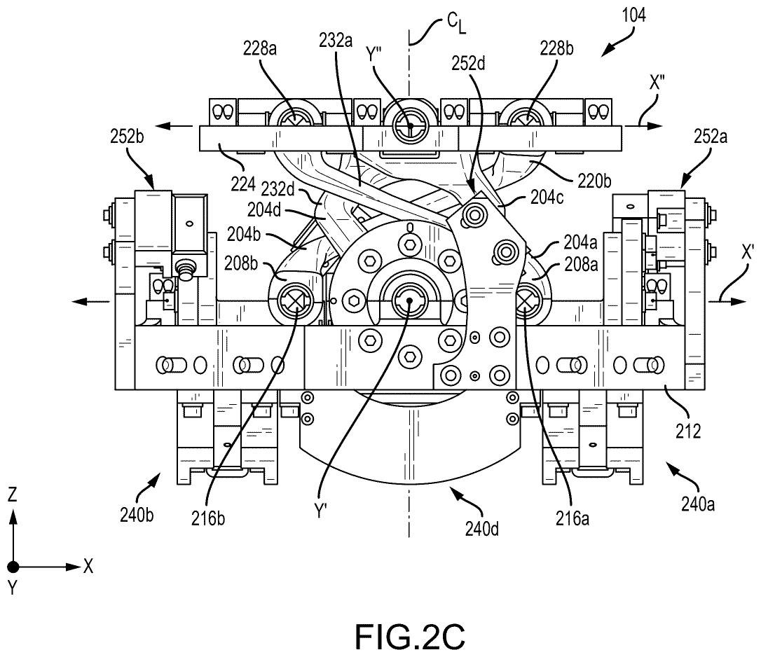

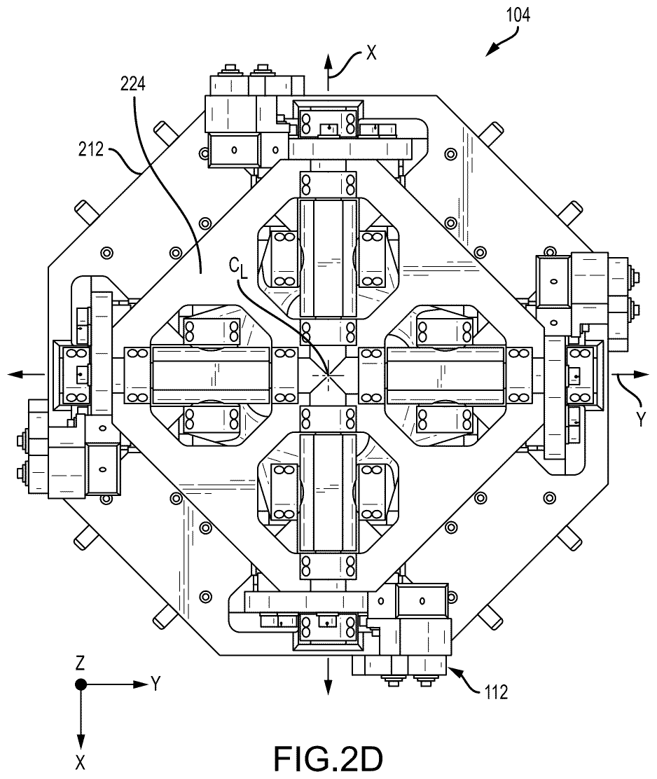

FIG. 2A is a top perspective view of a support assembly 104 in accordance with embodiments of the present disclosure; FIG. 2B is a first side elevation view of the support assembly 104 of FIG. 2A taken along the X axis; FIG. 2C is a second side elevation view of the support assembly 104 of FIG. 2A taken along the Y axis; and FIG. 2D is a top plan view of the support assembly 104 of FIG. 2A taken along the Z axis. In general, the support assembly 104 includes a plurality of arms or links 204. Each of the links 204 includes a first end or knuckle 208 that is connected to a base 212 component of the base assembly 112 by a base joint 216, and a second end or knuckle 220 that is connected to a platform 224 component to which the supported object can be interconnected by a platform joint 228. Each of the links 204 also includes a center section 232 that interconnects the first knuckle 208 to the second knuckle 220.

The base joints 216 are disposed in a base plane. The base plane can be parallel to or coincident with a plane of the base 212. In accordance with embodiments of the present disclosure, the base plane is defined by X′ and Y′ axes. The X′ and Y′ axes can be parallel to or coincident with the X and Y axes. Moreover, the first 216a and second 216b base joints can disposed along the X′ axis, and the third 216c and fourth 216d base joints can be disposed along the Y′ axis. The platform joints 228 are disposed in a platform plane. The platform plane can be parallel to or coincident with a plane of the platform 224. In accordance with embodiments of the present disclosure, the platform plane is defined by X″ and Y″ axes. The X″ and Y″ axes can be parallel to the X and Y axes, at least where the platform 224 is not tilted relative to the base 212 and the support assembly 104 is in a centered position (as depicted in FIGS. 2A-2D). The first 228a and second 228b platform joints can disposed along the X″ axis, and the third 228c and fourth 228d platform joints can be disposed along the Y″ axis.

The base joints 216 and platform joints 228 can be configured as universal joints or gimbals that allow an interconnected link 204 to pivot about two orthogonal axes. For instance, the base joints 216 can each allow an interconnected link 204 to pivot about a first axis that is parallel to the X′ axis and about a second axis that is parallel to the Y′ axis, and the platform joints 228 can each allow an interconnected link 204 to pivot about an axis that is parallel to the X″ axis and an axis that is parallel to the Y″ axis.

As can be appreciated by one of skill in the art, the first and second links 204a and 204b combine with the base 212 and the platform 224 to form the links of a first four bar linkage 236a, while the third and fourth links 204c and 204d combine with the base 212 and the platform 224 to form the links of a second four bar linkage 236b. The base joints 216a and 216b and the platform joints 228a and 228b included in the first four bar linkage 236a are disposed in a first linkage plane, and the base joints 216c and 216d and the platform joints 228c and 228d included in the second four bar linkage 236b are disposed in a second linkage plane. With the support assembly 104 in the centered or neutral position, the X and Z axes fall within or are parallel to the first linkage plane, and the Y and Z axes fall within or are parallel to the second linkage plane.

In accordance with embodiments of the present disclosure, the links 204 in each four bar linkage 236 are crossed with one another, forming X-shaped structures. Accordingly, the four bar linkages 236 may be configured as crossed four bar linkages. In at least some embodiments, the first 236a and the second 236b four bar linkages can be symmetrically disposed about the center line CL. Thus, the first link 204a is joined to the base 212 on a first side of the plane of the second four bar linkage 236b, the first link 204a is joined to the platform 224 on a second side of the plane of the second four bar linkage 236b, the second link 204b is joined to the base 212 on the second side of the plane of the second four bar linkage 236b, and the second link 204b is joined to the platform 224 on the first side of the plane of the second four bar linkage 236b. Similarly, the third link 204c is joined to the base 212 on a first side of the plane of the first four bar linkage 236a, the third link 204c is joined to the platform 224 on a second side of the plane of the first four bar linkage 236a, the fourth link 204d is joined to the base 212 on the second side of the plane of the first four bar linkage 236a, and the fourth link 204d is joined to the platform 224 on the first side of the plane of the first four bar linkage 236a. As a result of this configuration, a pivoting of the links 204 about a selected axis results in a tipping and a rotation of the platform 224 about the selected axis.

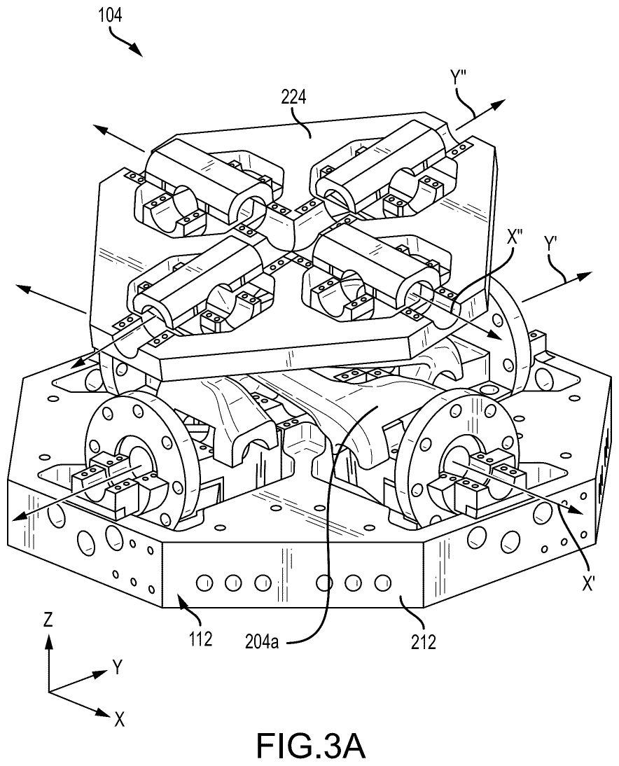

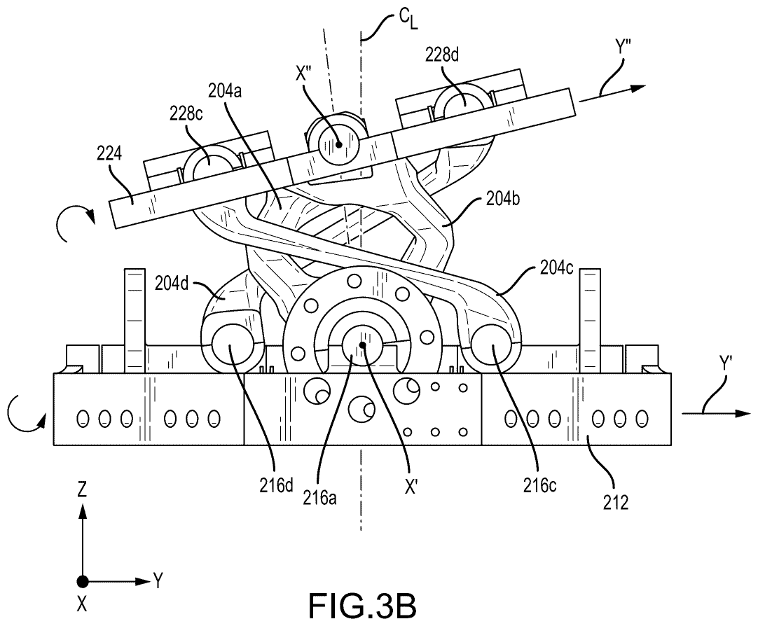

As depicted in FIGS. 3A and 3B, where the first 204a and second 204b links are pivoted at their respective base joints 216a and 216b about the X′ axis in a first direction, the third 204c and fourth 204d links are pivoted about axes passing through their respective base joints 216c and 216d that are parallel to the X′ axis in the first direction. In addition, the third 204c and fourth 204d links are pivoted about axes passing through their respective platform joints 228c and 228d that are parallel to the X″ axis in a second direction that is opposite to the first direction. As a result, the platform 224 is tipped in the first direction about an axis that is parallel to the X′ axis. In addition, the tipping of the platform 224 about the X′ axis in the first direction is accompanied by a rotation of the platform 224 about the X″ axis in the first direction. Moreover, this rotation of the platform 224 is accommodated by the platform joints 228a and 228b, which enables the platform 224 to rotate relative to a plane of the first 204a and second 204b links. By pivoting the first 204a and second 204b links about the X′ axis in a second direction that is opposite to the first direction, the platform 224 can be tipped in the second direction about an axis that is parallel to the X′ axis and at the same time the platform 224 can be rotated about the X″ axis in the second direction. As can be appreciated by one of skill in the art after consideration of the present disclosure, the location of the axis about which the platform 224 is tipped, the angle of the platform plane relative to the base plane as a result of pivoting the first 204a and second 204b links about the X′ axis and the extent of the accompanying rotation of the platform 224 about the X″ axis depend on the amount by which the first 204a and second 204b links are pivoted about the X′ axis, the length of the third 204c and fourth 204d links, the spacing between the third 216c and fourth 216d base joints, and the spacing between the third 228c and fourth 228d platform joints.

Where the third 204c and fourth 204d links are pivoted at their respective base joints 216c and 216d about the Y′ axis in a third direction, the first 204a and second 204b links are pivoted about axes passing through their respective base joints 216a and 216b that are parallel to the Y′ axis in the third direction. In addition, the first 204a and second 204b links are pivoted about axes passing through their respective platform joints 228a and 228b that are parallel to the Y″ axis in a fourth direction that is opposite to the third direction. As a result, the platform 224 is tipped in the third direction about an axis that is parallel to the Y′ axis, and the platform 224 is rotated about the Y″ axis in the third direction. By pivoting the third 204c and fourth 204d links about the Y′ axis in a fourth direction that is opposite to the third direction, the platform 224 can be tipped in the fourth direction about an axis that is parallel to the Y′ axis, and the platform 224 can be rotated about the Y″ axis in the fourth direction. The location of the axis about which the platform 224 is tipped, the angle of the platform plane relative to the base plane as a result of pivoting the third 204c and fourth 204d links about the Y′ axis, and the amount of the corresponding rotation of the platform 224 about the Y″ axis depends on the amount by which the third 204c and fourth 204d links are pivoted about the Y′ axis, the length of the first 204a and second 204b links, the spacing between the first 216a and second 216b base joints, and the spacing between the first 228a and second 228b platform joints.

In accordance with embodiments of the present disclosure, the platform 224 can be tipped about an axis parallel to the X′ axis and about an axis parallel to the Y′ axis simultaneously. In particular, where the links 204 are pivoted at the base joints 216 about axes parallel to or coincident with the X′ axis and are also pivoted at the base joints 216 about axes parallel to or coincident with the Y′ axis, the links 204 are also pivoted relative to the plane of the platform 224 along axes that are parallel to or coincident with the X″ axis and along axes that are parallel to or coincident with the Y″ axis. As a result, the platform 224 is tipped about both an axis that is parallel to the X′ axis and an axis that is parallel to the Y′ axis, and the platform 224 is rotated about the X″ axis and the Y″ axis.

In the embodiments shown in FIGS. 2A-2D, each link 204a-d is associated with an actuator 240a-d. The actuators 240 can include but are not limited to voice coil actuators or stepper motors. In the illustrated example, the actuators 240 are voice coil motors with a first component (e.g. a magnet) that is fixed to the base 212 and a second component (e.g. a selectively energized coil) that is fixed or interconnected to a portion of a base joint 216 that moves with an associated link 204. In accordance with at least some embodiments of the present disclosure, each actuator 240 is configured to pivot an interconnected link 204 about an axis that is coincident with the linkage plane in which the joints 216 and 228 of the link 204 are disposed. For example, the first 240a and second 240b actuators can be disposed along the X′ axis and can be operated to pivot the first 204a and second 204b links about the X′ axis, and thereby tip the platform 224 about an axis that is parallel to the X′ axis. Similarly, the third 240c and fourth 240d actuators can be disposed along the Y′ axis and can be operated to pivot the third 204c and fourth 204d links about the Y′ axis, and thereby tip the platform 224 about an axis that is parallel to the Y′ axis. Although two actuators 240 are depicted as being disposed along each of the orthogonal axes X′ and Y′, it should be appreciated that any number of actuators 240 can be provided to tip the platform 224 relative to each axis. For instance, the total number of actuators 240 included in the support assembly 104 can be two, with a first actuator 240 associated with one of the first 204a and second 204b links to tip the platform 224 relative to the X′ axis, and a second actuator associated with one of the third 204c and fourth 204d links to tip the platform 224 relative to the Y′ axis. Moreover, other dispositions of actuators 240 are possible. For example, actuators 240 that move with the platform 224 can be disposed along the X″ and Y″ axes, instead of or in addition to being disposed along the X′ and Y′ axes. As a further example, actuators 240 can be disposed along axes that intersect a joint 216 or 228 that are parallel to but spaced apart from at least one of the X′, X″, Y′, or Y″ axes.

A support assembly 104 in accordance with embodiments of the present disclosure can additionally include position sensors 252. The position sensors 252 can include encoders, eddy current sensors, differential impedance transducer type proximity sensors, or optical sensors. In the illustrated example, the position sensors 252 are encoders with a first component (e.g. an optical sensor) that is fixed to the base 212 and a second component (e.g. an optical encoder) that is fixed or interconnected to a portion of a joint 216 or 228 that moves with an associated link 204. Each position sensor 252 can be configured to measure an amount by which an associated link 204 is pivoted about an axis that is coincident with an axis of the linkage plane of the associated link 204. For example, first 252a and second 252b position sensors can be disposed along the X′ axis to measure an amount by which the first 204a and second 204b links are pivoted about the X′ axis, while third 252c and fourth 252d position sensors can be disposed along the Y′ axis to measure an amount by which the third 204c and fourth 204d links are pivoted about the Y′ axis. As can be appreciated by one of skill in the art after consideration of the present disclosure, the amounts by which a link 204 pivots about an axis can be applied to determine an amount by which the platform 224 has been tipped or rotated about that axis. Moreover, other configurations are possible. For instance, the support assembly 104 can be configured with only one position sensor 252 on each axis. As another example, position sensors 252 can be disposed to measure a rotation of links relative to the platform 224, as an alternative or in addition to being disposed to measure a rotation of links 204 relative to the base 212. In accordance with still further embodiments, position sensors 252 can be configured to measure a tilt of the platform 224 directly, rather than by measuring an amount by which links 204 have pivoted relative to the base 212 or the platform 224.

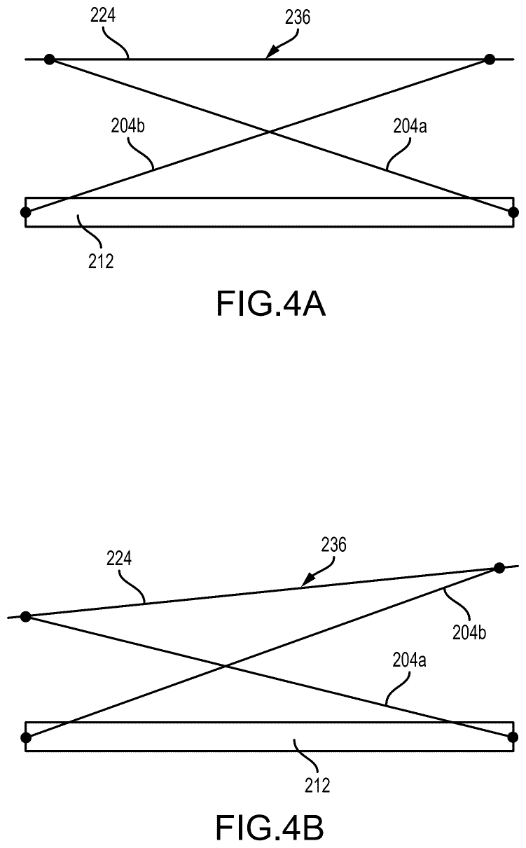

FIG. 4A and FIG. 4B depict a relationship between components of a four bar linkage 236 included in a support assembly 104 in accordance with embodiments of the present disclosure in a side elevation view. In particular, a relationship between components of a four bar linkage 236 with a platform 224 in a centered position relative to the base 212 is depicted in FIG. 4A, and a relationship between the components of the four bar linkage 236 with the platform 224 tilted relative to the base 212 is depicted in FIG. 4B. As illustrated in these figures, a point at which the links 204 within the four bar linkage 236 intersect varies with an amount by which the platform 224 is tilted relative to the base 212. Accordingly, the links 204 within any one of the four bar linkages 236 must be configured to allow for relative movement of the links 204, such as by creating a spacing between the links 204. In addition, with a support assembly 104 that includes two four bar linkages 236 disposed in intersecting planes, a spacing between the links 204 of the different four bar linkages 236 included in the support assembly 104 must be established in order to allow the platform 224 to move relative to the base 212. In accordance with embodiments of the present disclosure, the spacing necessary to accommodate movement of the links 204 relative to one another is accommodated by establishing an open volume around a center line C_{L} of the support assembly 104, where the center line extends along or parallel to the Z axis. This open volume can be formed by providing links 204 that each include a clearance feature. More particularly, the center section 232 of each link 204 within a four bar linkage 236 can be offset so that at least a portion of the center section 232 of one link 204 within that four bar linkage 236 is disposed on a side of the plane of the four bar linkage 236 that is opposite a side on which at least a portion of the center section 232 of the other link 204 within that four bar linkage 236 is disposed. With both four bar linkages 236 thus configured, and with the respective planes of the four bar linkages 236 intersecting along the center line C_{L}, where the planes are defined by the centers of the respective joints 216 and 228, and at least with the platform 224 centered relative to the base 212, a spacing around the center line C_{L} is established. In particular, in the completed support assembly 104, the links 204 can be symmetrically disposed about the center line C_{L}, so that the center section 232 of each link is offset to the same side, away from the center line C_{L}, thereby establishing an open clearance space or volume around the center line C_{L}. For example, in a top plan view, moving from a first end proximate the first knuckle 208 toward a second end proximate the second knuckle 220 of a link 204, the center line C_{L} of the support assembly 104 can be to the right of the center section of the link 204. Moreover, the offset of the center section 232 of each link 204 is configured so that a spacing between the links 204 and the center line is maintained for any tilt or angle of the platform 224 relative to the base 212 that is within the operating range of the support assembly 104.

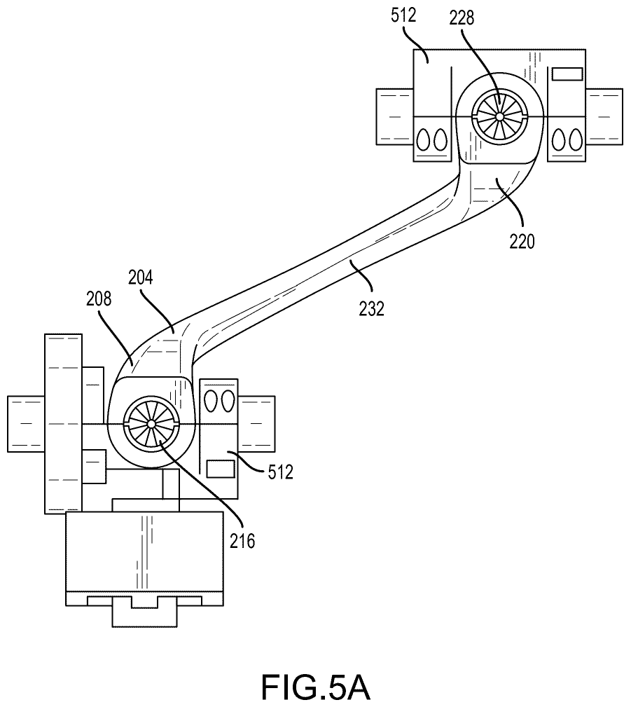

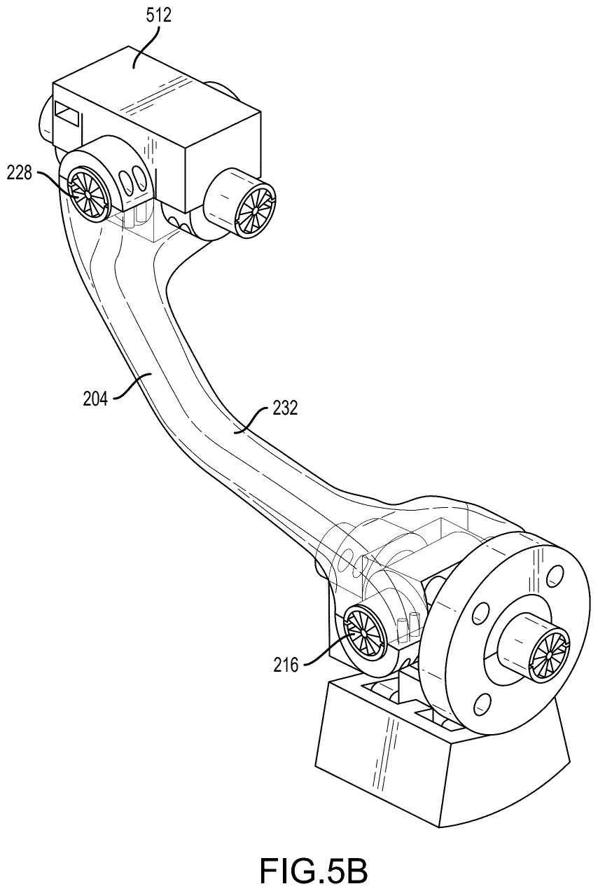

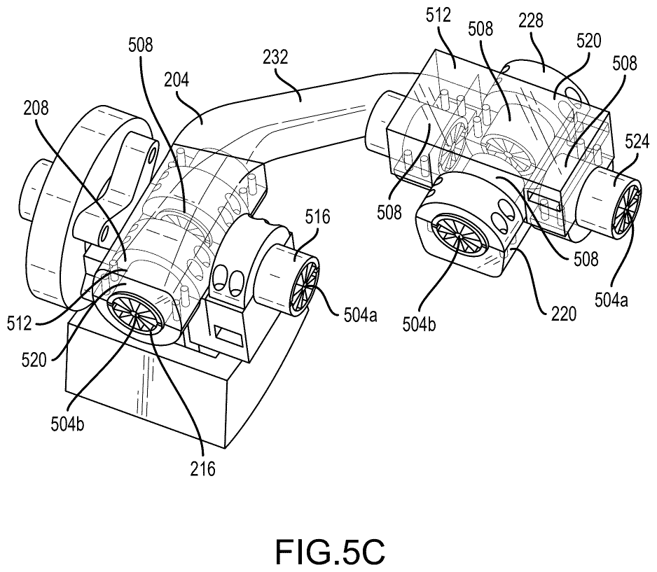

In accordance with embodiments of the present disclosure, the center section 232 of each of the links 204 is offset from the center line C_{L} of the support assembly 104 by angling or arching the center section 232 such that a distance between the center section 232 and a plane of the four bar linkage 236 in which the link is included increases with distance from a knuckle 208 or 220, until a maximum distance from the plane of the four bar linkage 236 is established at or about a midpoint between the knuckles 208 and 220. Alternatively or in addition, the center section 232 of each link 204 can be offset from the respective linkage plane for the entire length of the center section 232 by configuring the link 204 such that the center section 232 extends from a side of the knuckles 208 and 220. An example link 204 having a center section 232 that is both curved and offset in order to provide a clearance volume around the center line C_{L} of the support assembly 104 is depicted in FIGS. 5A-5C. As can be appreciated by one of skill in the art after consideration of the present disclosure, for a given four bar linkage 236 geometry, the larger the open area created around the center line C_{L} by the contour or curvature of the links 204, the greater the maximum angle of platform 224 tilt available.

In accordance with embodiments of the present disclosure, and as shown in FIG. 5C, the joints 216 and 228 are configured as universal joints or gimbals that allow an interconnected link 204 to pivot about two orthogonal axes. More particularly, a base joint 216 allows an interconnected link 204 to rotate about axes that are parallel to the X′ and Y′ axes, while a platform joint 228 allows an interconnected link 204 to pivot about axes that are parallel to the X″ and Y″ axes. In the example of FIG. 5C, each joint 216 and 228 is configured as first and second bearing assemblies 504a and 504b that are disposed along orthogonal axes and that have joining sections 508 that are interconnected to one another by a joining structure or block 512. Note that in FIG. 5C, the joining structure 512 is depicted as a transparent element in order to show the underlying components. In a base joint 216, a base section 516 of the first bearing assembly 504a is fixed to the base 212, and a link section 520 of the second bearing assembly 504b is fixed to the base knuckle 208 of a link 204. In a platform joint 228, a platform section 524 of the first bearing assembly 504a is fixed to the platform 224, and a link section 520 of the second bearing assembly is fixed to the platform knuckle 220 of a link 204. In accordance with embodiments of the present disclosure, the first bearing assembly 504a of a base joint 216 included in the first four bar linkage 236a is disposed along the X′ axis; the second bearing assembly 504b of the base joint 216 is disposed along an axis that is parallel to the Y′ axis; the first bearing assembly 504a of a platform joint 228 included in the first four bar linkage 236a is disposed along the X″ axis; and the second bearing assembly 504b of the platform joint 228 is disposed along an axis that is parallel to the Y″ axis. In addition, the first bearing assembly 504a of a base joint 216 included in the second four bar linkage 236b is disposed along the Y′ axis; the second bearing assembly 504b of the base joint 216 is disposed along an axis that is parallel to the X′ axis; the first bearing assembly 504a of a platform joint 228 included in the second four bar linkage 236b is disposed along the Y″ axis; and the second bearing assembly 504b of the platform joint 228 is disposed along an axis that is parallel to the X″ axis.

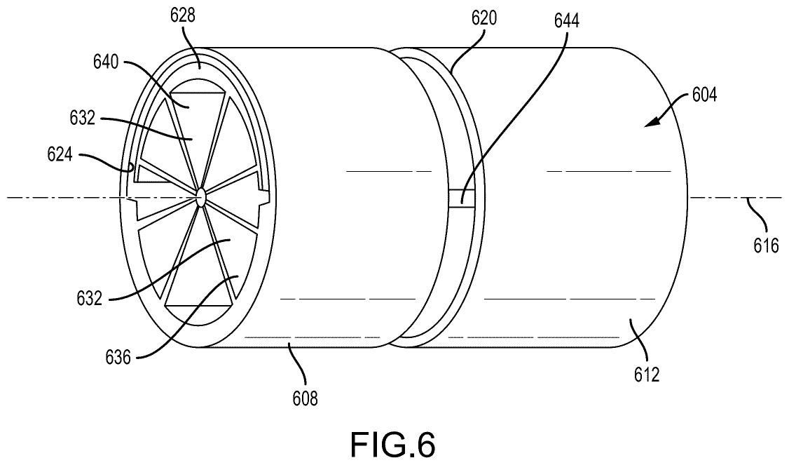

In accordance with embodiments of the present disclosure, the bearing assemblies 504 can be configured as pairs of flexure structures 604. As illustrated in FIG. 6, each flexure structure 604 can include a first section 608 that is axially aligned with and that can be rotated relative to a second section 612 about a center or pivot axis 616. The first 608 and second 612 sections are separated from one another by a circumferential groove 620. Each of the first 608 and second 612 sections includes a recessed portion 624 that receives a tab 628 that extends from the other section 608 or 612. The sections 608 and 612 are joined to one another by a set of resilient blades 632 that are centered on the pivot axis 616. Each blade 632 includes a first blade half 636 that extends from an interior surface of the first section 608 to along the pivot axis 616, and a second blade half 640 that extends from an interior surface of the second section 612 to along the pivot axis 616. A gap 644 disposed between an end of the recessed portions 624 and an edge of the tabs 628 sets a maximum rotation of the first 608 and second 612 portions. As can be appreciated by one of skill in the art, the use of flexure structures 604 provides a self-centering force that tends to return the support assembly 104 to a neutral position. The number, configuration, thickness, length, width, taper, and composition of the blades can be varied according to various considerations, including but not limited to the required load bearing capacity of the flexure structure 604. In accordance with embodiments of the present disclosure, different flexure structures 604 within a support assembly 104 can have different stiffnesses, to dampen resonance. Moreover, each flexure structure 604 can be formed from a monolithic piece of material, such as but not limited to titanium. Although each of the first 608 and second 612 sections are shown as having cylindrical exterior surfaces, other configurations are possible.

In accordance with further embodiments of the present disclosure, the bearing assemblies 504 can be formed as roller bearing, ball bearing, or plain bearing assemblies. However, as can be appreciated by one of skill in the art, the use of flexure structures 604 can have advantages as compared to roller, ball, or plain bearings. However, the limited rotational range of flexure structures 604 as compared to roller, ball, or plain bearings has prevented their use in certain applications. Because embodiments of the present disclosure can be configured to provide a given rotation of the platform 224 about a selected axis that is greater than a corresponding rotation of the links 204 about axes parallel to the selected axis, the use of flexure structures 604 is enabled even where relatively large platform 224 tilt angles are specified. Accordingly, embodiments of the present disclosure can be configured to provide relatively large platform 224 tilt angles. For example, embodiments can be configured to provide tilt angles of greater than +/−5°. As a further example, embodiments can be configured to provide tilt angles of any amount up to +/−20°. As still another example, embodiments can be configured to provide tilt angles of up to +/−45°.

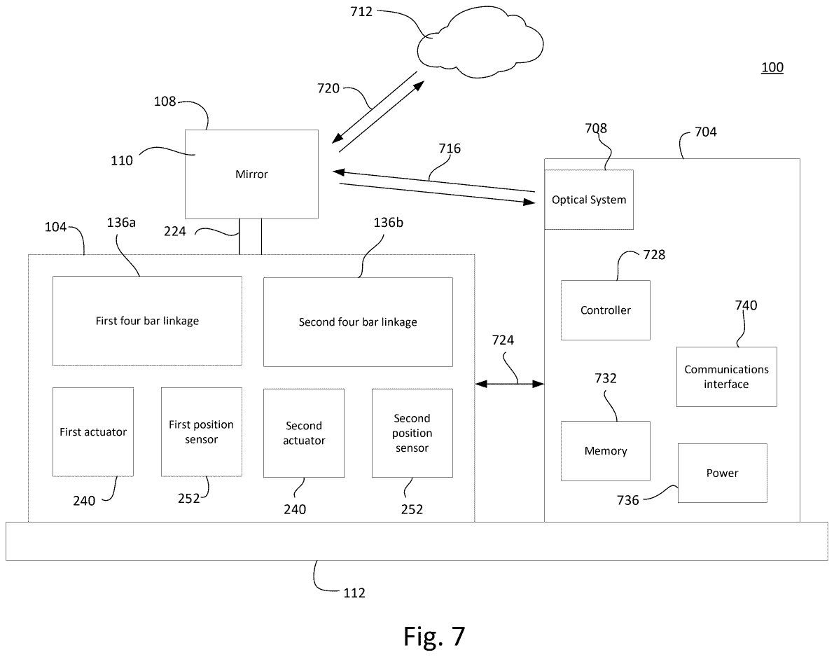

FIG. 7 is a functional block diagram depicting components of a system 100 in accordance with embodiments of the present disclosure. In this example, the system 100 includes a support assembly 104 that interconnects a base assembly 112 to a supported object 108, in this example a steering mirror 110. In addition, the system 100 includes system electronics 704. The system electronics 704 are joined to or provided as part of the base assembly 112, and implement a light based system, such as a laser detection and ranging (ladar) system, a light detection and ranging (lidar) system, or a free space optical communication system. Accordingly, the system electronics 704 can include, for example, but without limitation, an optical system 708. The optical system 708 can function to transmit, receive, or transmit and receive light passed between the optical system 708 and a target object or volume 712 external to the system 100 via the mirror 110. More particularly, a first segment of transmitted and/or received light beam 716 can be passed between the mirror 110 and the optical system over a fixed path, while a second segment of the transmitted and/or received light beam 720 can be passed between the mirror 110 and the target object or volume 712 over a variable or steered path or line of sight. As can be appreciated by one of skill in the art after consideration of the present disclosure, by selectively angling the mirror 110 relative to the optical system 708 and thereby controlling the pointing angle of the light beam 720, different target object or volume 712 locations relative to the system 100 can be accessed.

The mirror 110 is mechanically interconnected to the support assembly 104 via the platform 224. The angle of the mirror 110 relative to the optical system 708 can be selectively varied by controlling the support assembly 104. In particular, the angle of the mirror 110 about a first axis can be controlled by operating the first actuator 240 to move the first four bar linkage 136a of the support assembly 104. The angle of the mirror 110 about a second axis can be controlled by operating the second actuator 240 to move the second four bar linkage 136b of the support assembly 104. First and second position sensors 252 can be provided to measure the angle of the mirror 110 relative to the respective axes. Although shown positioned between the optical system 708 and the target object or volume 712 in FIG. 7, it should be appreciated that the mirror 110 can be located before or between various other optical components, such as mirrors, lenses, or filters that are provided as part of the optical system 708 or as additional optical elements.

Control signals for operating the actuators 240 and measurement signals generated by the position sensors 252 can be passed between the support assembly 104 and the system electronics 704 via one or more signal lines 724. The one or more signal lines 724 can include electrical, optical, or both electrical and optical signal lines. Moreover, the signal lines 724 can be provided as a plurality of dedicated signal lines and/or multiplex signal lines.

In addition to the optical system 708, the system electronics 704 can include various other components, such as but not limited to a controller 728, memory 732, a power supply 736, and a communications interface 740. The controller 728 can include a general purpose programmable processor or controller that executes firmware and/or software to perform the functions of the system electronics 704, such as operating or controlling the optical system 708 and various elements of the support assembly 104, such as operation of the actuators 240 in response to commands generated within or received by the controller 728 and in view of signals from the position sensors 252. The memory 732 can include solid-state or other memory or data storage systems or devices, and can be used to store operating instructions and software, data, and the like that can be applied by the controller 728. Operating instructions can be passed between the support assembly 104 and the system electronics 704 by the communications interface 740. The communications interface 740 can also support communications between the system electronics 704 and systems that are external to the system 100.

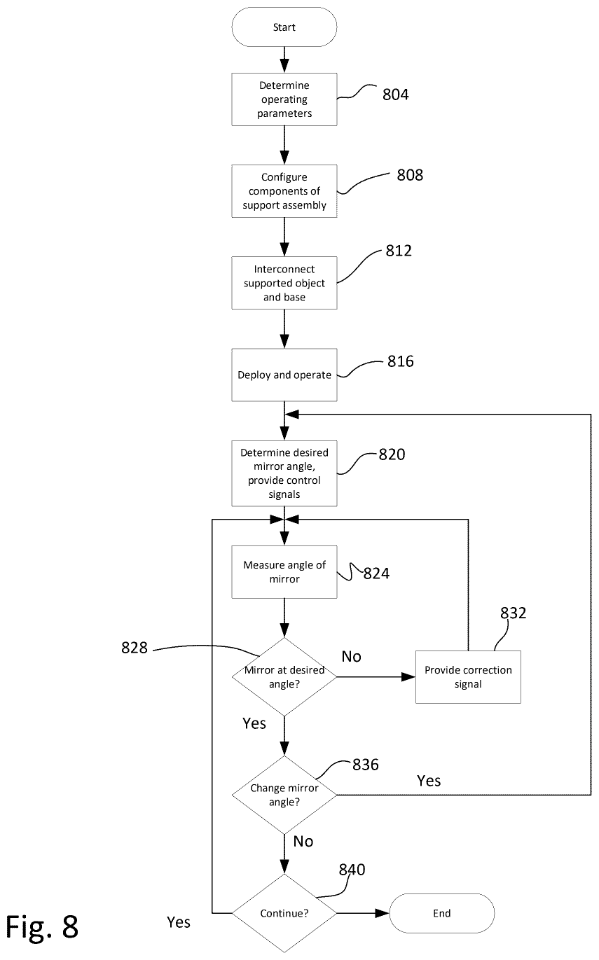

FIG. 8 is a flowchart depicting aspects of a method for providing and operating a system 100 incorporating a support assembly 104 in accordance with embodiments of the present disclosure. Initially, at step 804, operating parameters of the support assembly 104 are determined. For instance, a mass of the supported object 108 that will be interconnected to the support assembly 104 and the maximum required angular displacements of the supported object 108 are determined. The various components of the support assembly 104 can then be configured and assembled (step 808). The completed support assembly 104 can then be used to interconnect the supported object 108 and the base assembly 112 of the system 100 (step 812).

The system 100 can then be deployed and operated (step 816). For instance, the system 100 can be interconnected to a platform, such as a static platform or a vehicle, and operated. In accordance with at least some embodiments of the present disclosure, the system 100 operates by transmitting, receiving, or transmitting and receiving light over a selected line of sight. In such embodiments, the line of sight can be selectively pointed and/or scanned by selectively angling a supported object 108 in the form of a mirror 110 interconnected to the support assembly 104. Accordingly, at step 820, the system 100, can determine a desired angle of the mirror 110 relative to the base assembly 112, and can provide control signals to actuators 240 included in the support assembly 104 to place the mirror 110 at the desired angle. More particularly, a system controller 728 executing instructions stored in memory 732 can determine the desired angle of the mirror 110 and can generate control signals that are passed to the actuators 240. For instance, by selectively operating a first actuator 240 to rotate the base joints 216a-b of a first four bar linkage 236a about an axis intersecting those base joints 216a-b (e.g. an X′ axis) by a first amount, the mirror 110 can be selectively rotated about an axis that is parallel to the selected axis (e.g. an X″ axis) by a second amount that is greater than the first amount. Similarly, by selectively operating a second actuator 240 to rotate the base joints 216c-d of a second four bar linkage 236b about an axis intersecting those base joints 216c-d (e.g. a Y′ axis, where the Y′ axis is orthogonal to the X′ axis) by a third amount, the mirror 110 can be selectively rotated about an axis (e.g. a Y″ axis that is orthogonal to the X″ axis) by a fourth amount that is greater than the third amount. An actual angle of the mirror 110 relative to the axes can be measured by position sensors 252 (step 824). At step 828, a determination can be made as to whether the angle of the mirror 110 is equal to the desired angle. If the angle of the mirror 110 is not equal to the desired angle, a correction can be made by selectively operating an appropriate actuator 240 (step 832), and the process can return to step 824 to determine whether the desired angle has now been reached.

If it is determined at step 828 that the desired angle of the mirror 110 has been reached, a determination can next be made as to whether an angle of the mirror 110 should be changed (step 836). If the angle of the mirror 110 should be changed, the process can return to step 820. Alternatively, a determination can be made as to whether operation of the system 100 should be continued (step 840). If operation is to be continued, the process can return to step 824. Alternatively, the process can end.

Although various examples of a support assembly 104 used in combination with a supported object 108, such as a steering mirror 110, have been described, embodiments of the present disclosure are not so limited. For example, a support assembly 104 in accordance with embodiments of the present disclosure can be used as a support for any object, structure or component where it is desirable to provide two degrees of freedom of movement about (or nearly about) a fixed point between a base structure 112 and a supported object or assembly 108. Moreover, a support assembly 104 in accordance with embodiments of the present disclosure can be used in applications where a relatively high frequency of oscillation or change in angle is required or desirable. The support assembly 104 can also provide a self-centering force, which tends to bring the supported object 108 back to a neutral position relative to the base 112.

Embodiments of the present disclosure provide a support assembly 104 that allows larger angular travel than previous systems, with minimum pivot point translation or decenter, enabling a robust implementation of a motion control system. As an example, a relatively large angular rotation of a platform 224 of greater than +/−5° can be achieved. As a further example, embodiments can be configured to provide tilt angles of any amount up to +/−20°. As still another example, embodiments can be configured to provide tilt angles of up to +/−45°. In addition, embodiments of the present disclosure allow handling of higher dynamic loads than previous designs. The ability to support relatively high dynamic loads can also be enabled in combination with the aforementioned high angular displacements. In particular, embodiments of the present disclosure enable a given rotation at joints 216 and 228 to result in a rotation of a platform 224 and supported object 108 or mirror 110 integral with or joined to the platform 224 that is greater than a given rotation. This in turn enables flexure structures 604, which can have relatively high load bearing abilities, in addition to an ability to maintain a precisely controlled range of motion, to be used at the joints 216 and 228. The support assembly 104 disclosed herein can also be more compact than prior systems, allowing implementation in smaller devices. The provision of an open volume about a center line of the support assembly 104 provides clearance for the included links 204, enabling the supported object 108 to be selectively angled relative to the base 112, and allows for a drive well behind the supported object 108.

In accordance with still other embodiments of the present disclosure, a support assembly 104 can include a single four bar linkage 236, for example where rotation of a platform 224 about only one axis is required. In accordance with other embodiments, a support assembly 104 can include one four bar linkage 236 with base joints 216 that allow the links 204 of the four bar linkage 236 to rotate about a first axis, in combination with one additional link 204 having a base joint 216 that allows the additional link 204 to rotate about a second axis. Accordingly, a support assembly as disclosed herein is not limited to any particular number of links 204.

Advantages of embodiments of a support assembly 104 in accordance with embodiments of the present disclosure compared to alternative designs include: 1) enables a remote center pivot point that is at or relatively near a surface of the mirror 110; 2) enables large angular displacements about two axes; 3) minimizes drive inertia compared to a typical two axis gimbal; 4) enables voice coil actuators or stepper motors to drive linkages; 5) enables an angular position of the supported object 108 to be sensed using rotary optical encoders; and 6) can provide increased damping of resonance by incorporating flexures having different stiffnesses.

The foregoing description has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A support assembly, comprising:
a base;
a first link;
a second link;
a platform;
a first base joint, wherein the first base joint interconnects the first link to the base, and wherein the first base joint includes at least one flexure;
a second base joint, wherein the second base joint interconnects the second link to the base, and wherein the second base joint includes at least one flexure;
a first platform joint, wherein the first platform joint interconnects the first link to the platform, and wherein the first platform joint includes at least one flexure; and
a second platform joint, wherein the second platform joint interconnects the second link to the platform, and wherein the second platform joint includes at least one flexure;
wherein at least portions of the first base joint, the second base joint, the first platform joint, and the second platform joint are disposed in a first plane.

2. The support assembly of claim 1, further comprising:
a third link;
a third base joint, wherein the third base joint interconnects the third link to the base, and wherein the third base joint includes at least one flexure;
a third platform joint, wherein the third platform joint interconnects the third link to the platform, wherein the third platform joint includes at least one flexure, and
wherein at least portions of the third base joint and the third platform joint are disposed in a second plane that intersects the first plane.

3. The support assembly of claim 1, further comprising:
a third link;
a fourth link;
a third base joint, wherein the third base joint interconnects the third link to the base, and wherein the third base joint includes at least one flexure;
a fourth base joint, wherein the fourth base joint interconnects the fourth link to the base, and wherein the fourth base joint includes at least one flexure;
a third platform joint, wherein the third platform joint interconnects the third link to the platform, and wherein the third platform joint includes at least one flexure;
a fourth platform joint, wherein the fourth platform joint interconnects the fourth link to the platform, wherein the fourth platform joint includes at least one flexure,
wherein at least portions of the third base joint, the fourth base joint, the third platform joint, and the fourth platform joint are disposed in a second plane that intersects the first plane,
wherein a center section of the first link is disposed on a first side of the first plane,
wherein a center section of the second link is disposed on a second side of the first plane,
wherein a center section of the third link is disposed on a first side of the second plane, and
wherein a center section of the fourth link is disposed on a second side of the second plane.

4. The support assembly of claim 3, wherein the first and second links form a part of a first crossed four bar linkage, and wherein the third and fourth links form a part of a second crossed four bar linkage.

5. The support assembly of claim 3, wherein the first and second base joints are disposed along a first axis that is coincident with a base plane,
wherein the third and fourth base joints are disposed along a second axis that is coincident with the base plane, and
wherein the first axis is orthogonal to the second axis.

6. The support assembly of claim 1, wherein each of the base joints allows an interconnected link to pivot about two orthogonal axes.

7. The support assembly of claim 1, wherein each of the base joints allows an interconnected link to pivot about two orthogonal axes that are coincident with a base plane, and wherein each of the platform joints allows an interconnected link to pivot about two orthogonal axes that are coincident with a platform plane.

8. The support assembly of claim 1, wherein the base joints and the platform joints are universal joints.

9. The support assembly of claim 1, wherein the base joints and the platform joints each include a plurality of flexure structures.

10. The support assembly of claim 3, wherein, with the platform is positioned relative to the base such that a platform plane is parallel to a base plane, the first plane is orthogonal to the second plane, the first plane is orthogonal to the base plane, the first plane is orthogonal to the platform plane, the second plane is orthogonal to the base plane, and the second plane is orthogonal to the platform plane.

11. An assembly, comprising:
a support assembly, the support assembly including:
a base;
a platform;
a first four bar linkage, wherein the first four bar linkage is interconnected to the base along an X′ axis, and wherein the first four bar linkage is interconnected to the base along an X″ axis;
a second four bar linkage, wherein the second four bar linkage is interconnected to the base along a Y′ axis, and wherein the second four bar linkage is interconnected to the base along a Y″ axis
a first actuator, wherein the first actuator is disposed along the X′ axis and is operable to rotate the first four bar linkage about the X′ axis; and
a second actuator, wherein the second actuator is disposed along the Y′ axis and is operable to rotate the second four bar linkage about the Y′ axis.

12. The assembly of claim 11, wherein the first four bar linkage, includes:
first and second links,
first and second base joints, wherein the first base joint pivotally interconnects a first end of the first link to the base, and wherein the second base joint pivotally interconnects a first end of the second link to the base, and
first and second platform joints, wherein the first platform joint pivotally interconnects a second end of the first link to the platform, wherein the second platform joint pivotally interconnects a second end of the second link to the platform, and wherein the first and second base joints are disposed along the X′ axis,
wherein the second four bar linkage includes:
third and fourth links,
third and fourth base joints, wherein the third base joint pivotally interconnects a first end of the third link to the base, and wherein the fourth base joint pivotally interconnects a first end of the fourth link to the base; and
third and fourth platform joints, wherein the third platform joint pivotally interconnects a second end of the third link to the platform, wherein the fourth platform joint pivotally interconnects a second end of the fourth link to the platform, wherein the third and fourth base joints are disposed along the Y′ axis, and wherein the Y′ axis is orthogonal to the X′ axis, and
wherein a rotation of the first four bar linkage about the X′ axis tips the platform about an axis that is parallel to the X′ axis, and wherein a rotation of the second four bar linkage about the Y′ axis tips the platform about an axis that is parallel to the Y′ axis.

13. The assembly of claim 11, further comprising:
a supported object, wherein the supported object is fixed to the platform.

14. The assembly of claim 11, further comprising:
a mirror, wherein the mirror is fixed to the platform;
an optical system; and
a controller, wherein the actuators are operated by the controller to tip the platform and the mirror fixed to the platform to receive or transmit light between the optical system and a target volume.

15. The assembly of claim 11, wherein the assembly is a light detection and ranging system.

16. The assembly of claim 11, further comprising:
a first position sensor, wherein the first position sensor is disposed along the X′ axis; and
a second position sensor, wherein the second position sensor is disposed along the Y′ axis.

17. The assembly of claim 11, wherein the first four bar linkage is a crossed four bar linkage that is centered about a center line of the assembly, and wherein the second four bar linkage is a crossed four bar linkage that is centered about the center line of the assembly, and wherein the first and second four bar linkages include clearance features to form an open volume about a portion of the center line of the assembly.

18. The assembly of claim 12, wherein the first and second base joints are centered about a center line of the assembly, wherein the third and fourth base joints are centered about the center line of the assembly, and wherein the links are configured such that an open volume is formed about a portion of the center line of the assembly.

19. The assembly of claim 11, wherein the four bar linkages each include a clearance feature, and wherein a maximum tilt angle of the platform about each of X″ and Y″ axes is greater than +/−5°.

20. A method for supporting an object, comprising
determining a desired pointing angle of a light beam;
based on the determined desired pointing angle of the light beam, generating a control signal for an actuator; and
operating the actuator to pivot first and second crossed four bar linkages about a first axis by a first amount, wherein a mirror supported by the first and second crossed four bar linkages is rotated about an axis that is parallel to the first axis by a second amount, and wherein the second amount is greater than the first amount.
